(19) United States
(12) Patent Application Publication
(10) Pub. No.: US 2006/0227472 A1
(43) Pub. Date: Oct. 12, 2006

(54) Inverter ground fault circuit

(76) Inventors: William Taylor, Bend, OR (US); Brian Hoffman, Bend, OR (US)

Correspondence Address: John Vanden Bosche, 6571 Lunde Rd, Everson, WA, 98247, US

(21) Appl. No.: 11/187,059

(22) Filed: Jul. 22, 2005

Related U.S. Application Data
(60) Provisional application No. 60/669,487, filed on Apr. 7, 2005.

(51) Int. Cl. H02H 3/00

(52) U.S. Cl. 361/42

(57) ABSTRACT

A batteryless inverter allows for a positive or a negative lead from a photovoltaic array to be attached to a grounding terminal of the inverter. Internally a ground fault voltage is rectified and processed to produce a signal that will shut down the inverter. This signal will be the same whether the ground fault voltage is positive, negative, or AC.

### RELATED APPLICATIONS

This application claims priority under 35 U.S.C. §119(e) to U.S. Provisional Patent Application No. 60/669,487 which was filed on Apr. 7, 2005 and which is incorporated herein by reference.

### FIELD OF THE INVENTION

The invention relates to ground fault interruption for grid-tied, off-grid, or hybrid power inverters.

### BACKGROUND OF THE INVENTION

The solar energy industry is expanding at a rapid pace. Much of that expansion is due to increases in residential and small commercial photovoltaic (PV) installations. Increasingly these installations are directly connected to the utility grid without the use of batteries. Inverters are the power electronics equipment that converts DC electricity produced by the PV panels into AC required by the grid. Until recently most PV installations involved a battery bank for storing electricity since these installations were designed to provide back up power or were situated “off-grid” without a utility to supply or accept power. It is common practice to ground the negative terminal of a battery bank. Inverters designed for use with batteries often are designed to have a grounded negative terminal. This design practice has continued in development of batteryless inverters used for direct grid connection of PV arrays.

A ground fault in a PV array can be a serious problem and operation of an inverter should cease until the problem is remedied. Many PV Systems employ a ground fault interruption circuit external to the inverter to provide ground fault interruption (GFI).

It would be advantageous to provide an inverter with an internal GFI circuit.

It has been recently discovered that certain photovoltaic panels actually perform better when the positive terminal is grounded instead of the negative terminal.

It would be advantageous to provide an inverter which will allow for grounding the positive terminal of a PV array.

### SUMMARY OF THE INVENTION

The disclosed invention provides an inverter capable of accepting a positive or a negative ground and provides ground fault protection in the case of a positive, negative or AC voltage short to ground.

A chosen terminal (either positive or negative) of a PV array is connected to a grounding terminal on the inverter. This attachment point is electrically connected to earth ground through a low amperage fuse, relay, or other tripping device. In the case of a ground fault, current through this tripping device will create an open circuit. A rectifier between the attachment point and earth ground provides a DC voltage insensitive to the polarity or scale of the voltage or whether it is AC or DC. This voltage is conditioned to send a signal which triggers a relay initiating an inverter shut down.

Additional features and advantages according to the invention in its various embodiments will be apparent from the remainder of this disclosure.

### BRIEF DESCRIPTIONS OF THE DRAWINGS

Features and advantages according to embodiments of the invention will be apparent from the following Detailed Description taken in conjunction with the accompanying drawings, in which:

FIG. 1 shows a simplified schematic of the ground fault interruption apparatus of the present invention

FIG. 2 shows an embodiment of a ground fault interruption apparatus of the present invention.

FIG. 3 is a flow chart showing the process of ground fault interruption using the circuit shown in FIG. 2.

### DETAILED DESCRIPTION OF THE DRAWINGS

A method of ground fault detection and interruption is disclosed herein. The ground fault interrupter is useful for power inverters in either grid-tied, off-grid, or hybrid solar electricity generation applications. The inverter can also be utilized for generation sources other than photovoltaic systems. An embodiment of that method is further disclosed using a specific circuit. The description of a specific embodiment herein is for demonstration purposes and in no way limits the scope of this disclosure to exclude other not specifically described embodiments of the method of the present invention.

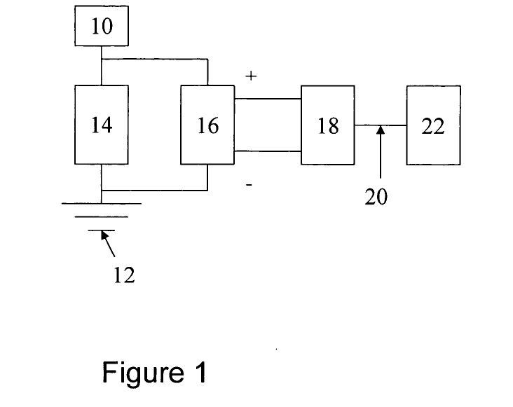

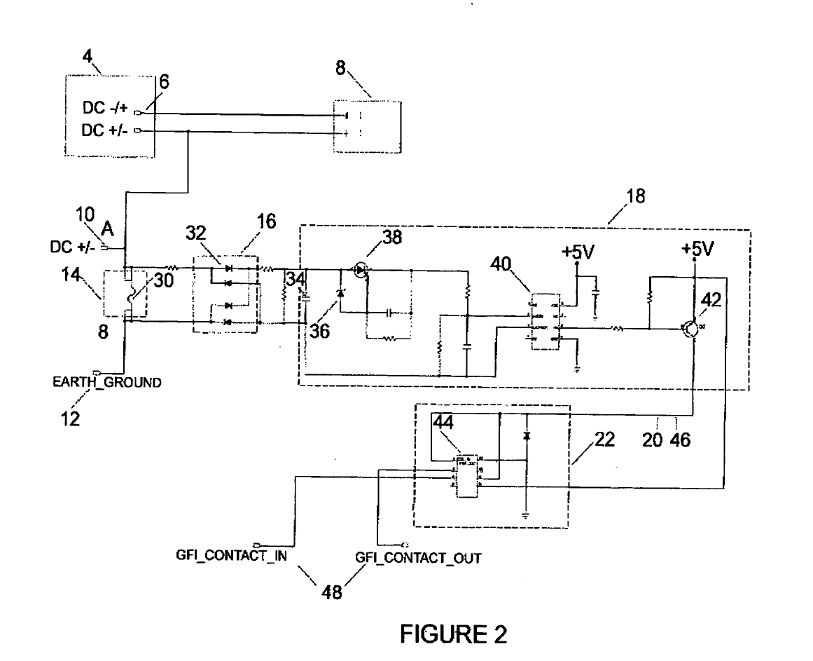

FIG. 1 shows a schematic of the present invention. A positive or negative lead of a photovoltaic (PV) array 4 is connected to a ground terminal 10 of an inverter. The other lead negative or positive from the PV array 4 connects to a DC Terminal 6. The DC power electronics 8 of an inverter is connected to the DC terminal 6 and ground terminal 10. The ground terminal 10 is a system ground for the inverter that can take the form of a ground lug, the inverter chassis, a ground wire, or other grounding point. The ground terminal 10 represents a point in the inverter system that is nominally at the same voltage as earth ground. In the event of a ground fault, the ground terminal 10 will be at a different voltage than earth ground and electrical current will flow from the ground terminal 10 to earth ground. The ground terminal 10 is electrically connected to earth ground 12 through a fuse device 14 that is installed in series with an electrical conductor that connects the ground terminal 10 to earth ground. A “fuse device” 14 is defined for use herein as any overcurrent tripping device such as a fuse, a circuit breaker, a relay connected to a current sensor, or other another tripping device that presents a closed circuit when electrical current is below a predetermined threshold current and then trips to an open circuit state when electrical current exceeds the predetermined threshold current. The fuse device 14 is designed to trip at a low amperage, one amp for example. The level of the predetermined threshold current that causes the fuse device 14 to trip can be designed by one of ordinary skill in the art depending on a variety of factors including size of electrical cables, resistivity to earth ground, location of the inverter, sensitivity of electronic components, and safety concerns. Normally there will be no significant voltage difference between points marked A and B in FIG. 1 due to their electrical connection through the fuse device 14. A ground fault within the solar array 4 will cause a significant current to flow through the fuse device 14. When this current exceeds the designed amperage the fuse device 14 will trip, opening the connection between the ground terminal 10 and earth ground 12. When the fuse device 14 has tripped in a ground fault situation there will be a voltage between points A and B. This voltage may be positive, negative or AC depending of the configuration of the array and nature of the fault. Points A and B are at the input to a rectifier 16 which converts the input, regardless of the sign or frequency of the voltage, into a DC voltage at the output. A simple and economic embodiment of the rectifier 16 is an H bridge using appropriately rated diodes. The rectifier 16 could be a passive rectifier, as shown in FIG. 2, or it could be an active rectifier. Other rectification circuits 16 will be apparent to one skilled in the art are included within the scope of this disclosure.

The DC voltage from the rectifier is optionally passed into a conditioning circuit 18. This conditioning circuit 18 converts the input DC voltage into a signal 20. The signal 20 activates a switch 22, which shuts down the inverter. The signal 20 may be a DC voltage, a digital signal, or any other means of activating the switch 22, including the raw voltage from the rectifier 16. The conditioning circuit 18 may be any circuit suitable for converting the raw DC voltage into the desired signal 20. The desired signal 20 is one which will reliably activate the switch 22. The switch 22 may be a relay, a switch, a computer circuit, or any other device simple or complex which will cause to be shut down all or part of inverter function, and/or disconnect the inverter from the DC. and/or AC energy sources. The purpose of the switch 22 is to protect the inverter, personnel, and/or equipment electrically contacted to the inverter during a ground fault.

FIG. 2 shows a specific embodiment of the present invention. The specific components of this embodiment will be described in relation to the generic elements disclosed in FIG. 1. In the shown embodiment the fuse device 14 connecting a grounding terminal 10 and the earth ground 12 is in the form of a fast acting fuse 30. An H-bridge diode arrangement 32 is the rectifier 16 in the shown embodiment. A conditioning circuit 18 contains a low pass filter 34, a Zener diode 36, a silicone controlled rectifier (SCR) 38, an opticupler 40, and a transistor 42. The purpose of the conditioning circuit 18 is to convert the rectified voltage across the fuse device 14, as rectified by the rectifier circuit 16, into a signal that can be reliably detected by the switch 22. The rectified voltage from across fuse device 14 may have any arbitrary magnitude, depending on the nature of the ground fault. Also, it may have a complex waveform in the case that the fault is an AC fault that has been rectified into a DC voltage. The voltage across the fuse device 14 may include electrical noise in the form of time-varying voltage level. Ideally, the conditioning circuit 18 converts voltage from across the fuse device 14, as rectified by the rectifier circuit 16, into a binary signal with known properties that can be reliably detected by the switch 22. The specific properties of the output of the conditioning circuit 18 depend on the design of switch 22. One of ordinary skill in the art can design a suitable conditioning circuit 18 for compatibility with the switch 22.

The switch 22 as shown in this embodiment is a latching relay 44. It will be evident to one skilled in the art that the conditioning circuit 18 will only allow a voltage to reach the opticoupler 40 when the voltage has reached a threshold voltage as determined my the specification of the Zener Diode 36 chosen. The shown conditioning circuit 18 will optically isolate the voltage signal, and trigger a transistor 42. The transistor 42 when activated generates a signal 20 in the form of a current 46 flowing to the latching relay 44 (or interrupts a current already flowing to the relay 44). Activation of the latching relay 44 initiates a shut down by changing the connective state (open or closed) of GFI contacts 48 from a normal operating connection (closed or open). In one embodiment an AC sensing line is passed through the relay 44 via the GFI contacts 48. In this embodiment the relay is closed during normal operation so that the voltage sense signal is passed through the relay. In this embodiment a computer within the inverter, no longer sensing AC from the grid when the relay opens due to a fault, shuts the inverter down and displays an error message. In other conceived embodiments the relay 44 would directly disconnect the AC or DC inputs to the inverter or send or interrupt a signal to initiate a shut down.

Embodiments of the present invention may have an inverter chassis grounded at the grounding terminal 10 thus the GFI circuit of the present invention will trip at any point the chassis is at a voltage other than earth ground 12. Further embodiments may ground the neutral leg of an AC output from the inverter to the chassis or grounding lug 10. With the neutral leg of the AC output grounded to the grounding lug 10 ground faults on the AC side of the inverter will trip the ground fault device of the present invention. Further embodiments of the present invention may be used exclusively on the AC output of a device, be it an inverter or other device requiring ground fault protection. The present invention will be triggered at any time the voltage at the grounding lug 10 is significantly different from that of earth ground 10. Depending on configuration this device can detect ground faults on the DC input, AC output, and/or internally.

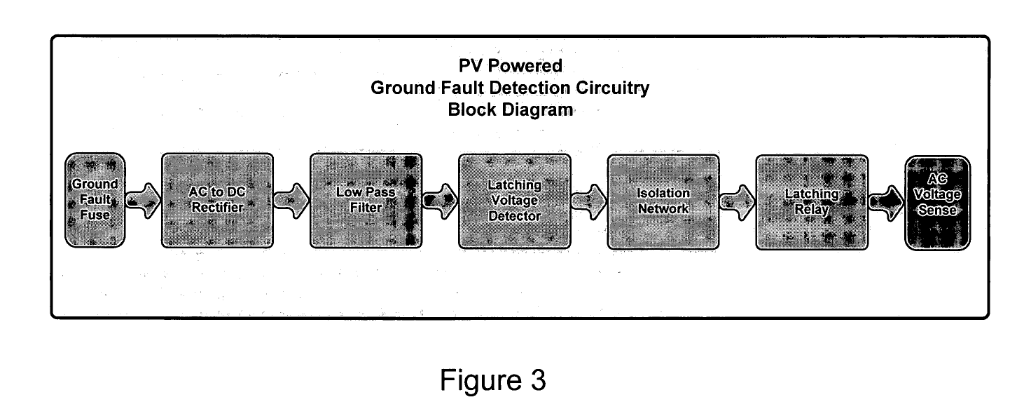

FIG. 3 is a flow chart showing stages of operation of the ground fault interruption circuit shown in FIG. 2. In the event of a ground fault in the PV array 6, within the inverter DC circuitry 8, or elsewhere in the DC circuitry, a ground fuse is blown 50, and the resultant voltage is passed through a rectifier 52. The rectified voltage is passed through a low pass filter 54 eliminating sharp spikes in voltage. The voltage then passes to a latching voltage detector 56 which only allows voltage to pass if it has reached a specific threshold. The voltage is then passed into an optical isolation network 58 which optically isolates a resultant signal from the input voltage. The signal out from the optical isolation network 58 activates a latching relay 60 which cuts the AC voltage sense line 62 initiating a shut down of the inverter.

While an embodiment of the invention has been shown and described, it will be apparent to those skilled in the art that various modifications may be made without departing from the scope of the invention. Therefore, it is intended that the invention not necessarily be limited to the particular embodiments described and illustrated herein.

What is claimed is:

1. A ground fault detection apparatus for use in an inverter connected to a photovoltaic panel comprising:
a ground conductor that connects a system ground in said inverter to earth ground;
a fuse device in series with said ground conductor;
a rectifier circuit connected in parallel with said fuse device;
a voltage detector that detects a rectified voltage across said fuse device; and
a switch that interrupts an electrical circuit within said inverter when a voltage is detected across said fuse device.

2. The ground fault detection apparatus of claim 1 wherein said fuse device is a fuse.

3. The ground fault detection apparatus of claim 1 wherein said fuse device is a circuit breaker.

4. The ground fault detection apparatus of claim 1 wherein said fuse device is a current sensor and a relay.

5. The ground fault detection apparatus of claim 1 wherein said fuse device is a relay.

6. The ground fault detection apparatus of claim 1 wherein said rectifier circuit produces a DC output with a predetermined voltage polarity regardless of the polarity of voltage across said fuse device and regardless of whether the voltage across said fuse device is AC or DC.

7. The ground fault detection apparatus of claim 6wherein said rectifier circuit comprises a plurality of diodes arranged to form a passive rectifier.

8. The ground fault detection apparatus of claim 7 wherein said rectifier circuit is an H bridge circuit.

9. The ground fault detection apparatus of claim 1 further comprising a signal conditioning circuit that converts said rectified voltage across said fuse to a signal in a different form that is appropriate for input to said voltage detector.

10. The ground fault detector apparatus of claim 9 wherein said signal conditioning circuit comprises an opticoupler.

11. The ground fault detector apparatus of claim 9 wherein said signal conditioning circuit comprises a low pass filter.

12. The ground fault detector apparatus of claim 9 wherein said signal conditioning circuit comprises a Zener diode whereby said switch does not interrupt an electrical circuit within said inverter until said voltage across said fuse device exceeds a predetermined threshold level.

13. The ground fault detector apparatus of claim 9 wherein said signal conditioning circuit comprises a transistor.

14. The ground fault detector apparatus of claim 9 wherein said signal conditioning circuit produces a binary signal with predetermined characteristics regardless of the magnitude and waveform of said rectified voltage across said fuse.

15. A solar generation system comprising: a photovoltaic panel;
an inverter electrically connected to said photovoltaic panel for conditioning the output of said photovoltaic panel; and
a ground fault interrupter in said inverter comprising:
a ground conductor that connects a system ground to earth ground;
a fuse device in series with said ground conductor;
a voltage detector that detects a voltage across said fuse device; and
a switch that interrupts an electrical circuit within said inverter when a voltage is detected across said fuse device.

16. The solar generation system of claim 15 further comprising a rectifier circuit connected in parallel with said fuse device and wherein the voltage presented to said voltage detector has a polarity that is independent of the polarity and frequency of said voltage across said fuse device.

17. The ground fault detection apparatus of claim 16 wherein said rectifier circuit comprises a plurality of diodes arranged to form a passive rectifier.

18. The ground fault detection apparatus of claim 17 wherein said rectifier circuit is an H bridge circuit.

19. The ground fault detection apparatus of claim 16 further comprising a signal conditioning circuit that converts said rectified voltage across said fuse to a signal in a different form that is appropriate for input to said voltage detector.

20. The ground fault detector apparatus of claim 19 wherein said signal conditioning circuit produces a binary signal with predetermined characteristics regardless of the magnitude and waveform of said rectified voltage across said fuse.

21. A method of detecting a ground fault in an inverter comprising the steps of:
providing a system ground within said inverter;
providing a ground conductor between said system ground and earth ground;
providing a fuse device in series with said ground conductor that trips when electrical current in said ground conductor exceeds a predetermined level;
rectifying voltage across said fuse device whereby said rectified voltage is a DC voltage with a polarity that does not depend on the polarity of voltage across said fuse device and does not depend on whether voltage across said fuse device is AC or DC; and detecting said rectified voltage across said fuse device as an indication of a ground fault condition.

22. The method of claim 21 further comprising the step of conditioning said rectified voltage.

23. The method of claim 22 wherein said step of conditioning said rectified voltage comprises the step of filtering high frequency electrical noise from said rectified voltage.

24. The method of claim 22 wherein said step of conditioning said rectified voltage comprises the step of blocking said voltage when it is less than a predetermined threshold value.

25. The method of claim 22 wherein said step of conditioning said rectified voltage comprises the step of optically isolating said voltage from a circuit that detects said voltage.

26. The method of claim 22 wherein said step of conditioning said rectified voltage comprises the step of converting said rectified voltage into a current signal with predetermined magnitude when said rectified voltage is above a predetermined threshold value.

27. The method of claim 21 further comprising the step of activating a switch to interrupt a circuit within said inverter when a ground fault condition is detected.
